(19) United States
(12) Patent Application Publication
(10) Pub. No.: US 2018/0300301 A1
(43) Pub. Date: Oct. 18, 2018

(54) ENHANCED INKING CAPABILITIES FOR CONTENT CREATION APPLICATIONS

(71) Applicant: Microsoft Technology Licensing, LLC, Redmond, WA (US)

(72) Inventors: Ian Mikutel, Redmond, WA (US); Gilles L. Peron, Issaquah, WA (US); Nassr Albahadly, Kirkland, WA (US)

(21) Appl. No.: 15/490,720

(22) Filed: Apr. 18, 2017

(51) Int. Cl. G06F 17/24; G06K 9/00; G06T 11/60; G06F 3/0488

(52) U.S. Cl. CPC G06F 17/242; G06F 3/04883; G06T 11/60; G06K 9/00422

(57) ABSTRACT

Enhanced inking capabilities for content creation applications are provided. The content creation application may recognize inked words and return a text-based version of the inked word. Through an inked drawing feature, the content creation application can send the inked word or text-based version to the ink drawing service that hosts a data resource with inked drawings. The ink drawing service can use the inked word to search tags of inked drawings in the data resource and relevant inked drawings can be returned to the content creation application. Users can select to insert an inked drawing into a canvas interface of the content creation application. The user can then interact with the inked drawing as if they had done the drawing themselves by, for example, modifying color or thickness of any of the ink strokes of the inked drawing, adding or removing ink strokes, and annotating the inked drawing.

### BACKGROUND

As developers try to build software that creates easier ways for users to communicate ideas they have into digital representations, the developers typically optimize for users who are verbal learners (those who learn by words, talking, listening, reading and writing). However, studies have shown that most users are visual learners (those who prefer to learn by using pictures, diagrams, and images). While most learners are visual, many learners cannot draw well, and thus are unable to express their ideas in a visual manner.

### BRIEF SUMMARY

An inked drawing feature and an ink drawing service are provided for enhanced inking capabilities for content creation applications. The inked drawing feature of the content creation application and ink drawing service can convert words to drawings that can then be modified through inking methods.

A content creation application with an inked drawing feature can receive ink strokes through a canvas interface of the content creation application and perform ink analysis on the ink strokes to identify an inked word drawn by the ink strokes. The content creation application can convert the inked word to an inked drawing by requesting ink results from an ink drawing service. The ink results comprise inked drawings having an ink modifiable format. When the ink results are received from the ink drawing service the results can be provided by the content creation application to the user for insertion of an inked drawing into the canvas interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which various embodiments of the invention may be carried out.

FIG. 2 illustrates an example process flow diagram of a method for enhanced inking.

FIGS. 3A-3C illustrate a sequence diagram with example process flows.

FIGS. 4A-4D and 5A-5D illustrate example scenarios of enhanced inking carried out at a content creation application.

FIG. 6 illustrates components of a computing device that may be used in certain embodiments described herein.

FIG. 7 illustrates components of a computing system that may be used to implement certain methods and services described herein.

### DETAILED DESCRIPTION

An inked drawing feature and an ink drawing service are provided for enhanced inking capabilities for content creation applications. The inked drawing feature of the content creation application and ink drawing service can convert words to drawings that can then be modified through inking methods.

Content creation applications are software applications in which users can contribute information. As used herein, content creation applications are directed to visual content where users can create text and/or image-based content in digital form. The term “content creation application” may in some cases by synonymous with “content authoring application”, “productivity application”, or “content authoring tool”. Since the described systems and techniques focus on applications and tools through which content is being authored, there is no distinction intended between these terms and such terms may be used interchangeably herein.

The described inked drawing feature is suitable for any content creation application that supports “inking” or “digital ink”, which refers to the mode of user input where a stylus or pen (or even user finger on a touch screen or pad) is used to capture handwriting in its natural form.

A content creation application may use an ink analyzer (IA), locally or via a service, to recognize handwritten words (e.g., “inked words”) from inputted strokes of a “pen” (e.g., stylus, pen, finger, or possibly a pen draw function controlled via a mouse) and determine a text-based version of the inked word. For the inked drawing feature, an inked word can be converted to an inked drawing in a canvas interface (the graphical user interface providing a visual representation of what the user has inked) of the content creation application. The drawing feature communicates with an ink drawing service to achieve the conversion. The ink drawing service manages an inked drawing data resource that stores inked drawings. The text-based version of the inked word can be used by the ink drawing service to search the inked drawing data resource and identify inked drawings corresponding to the inked word. For example, the ink drawing service can use the inked word to search tags of inked drawings in the data resource and relevant inked drawings can be returned to the content creation application. The results from the ink drawing service can be provided back to the content creation application and a user can select to insert an inked drawing into the canvas interface.

The user can then interact with the inked drawing as if they had done the drawing themselves by, for example, modifying color or thickness of any of the ink strokes of the inked drawing, adding or removing ink strokes, and annotating the inked drawing.

An ink stroke refers to a set of properties and point data that a digitizer captures that represent the coordinates and properties of a “marking”. It can be the set of data that is captured in a single pen down, up, or move sequence. The set of data can include parameters such as, but not limited to, a beginning of the stroke, an end of the stroke, the pressure of the stroke, the tilt (e.g., of a pen) for the stroke, the direction of the stroke, the time and timing of the stroke between discrete coordinates along the path of the stroke, and the color of the ‘ink’.

A digitizer generally provides a set of coordinates on a grid that can be used to convert an analog motion into discrete coordinate values. A digitizer may be laid under or over a screen or surface that can capture the movement of a finger, pen, or stylus (e.g., the handwriting or brush strokes of a user). Depending on the features of the digitizer, information such as pressure, speed of motion between points, and direction of motion can be collected.

A grouping of ink strokes that are identified as forming a drawn unit (e.g., word or drawing) can be considered stored within a data structure of an ink container. The ink container can include metadata associated with the word or drawing as well as the ink stroke parameters for each ink stroke in the ink container.

With digital ink, a user can easily control the appearance of the inked word or inked drawing, just like in the real world, because of the data structure (and language) of the ink strokes, which involve the above referenced parameters (e.g., coordinates, pressure, etc.). By remaining in the form of ink strokes, inked words, as well as inked drawings, are in an ink modifiable format.

In contrast to an inked drawing, which would be composed of ink strokes (and their associated parameters, still images are not in a format that allows a user to modify the drawing. Examples of still drawings and images include clip art images, ready-made shapes (e.g., lines, basic shapes, arrows, flowcharts, etc.), and camera images. Although it can be possible to format and/or edit certain still drawings, the available editing tools and editable components (e.g., line, color, angle) may be limited.

The inked drawing feature allows for the recognition of handwritten (inked) words that returns related handwritten (inked) drawings, as well as the ability for users to search for, select and use handwritten (inked) drawings from a community of other users within the same content creation application.

In some further implementations, the inked drawing feature allows users the ability to modify, edit and remix the ink content taken from the ink drawing service and re-upload the modified inked drawing back to the ink drawing service as their own inked drawing for others in the community to use.

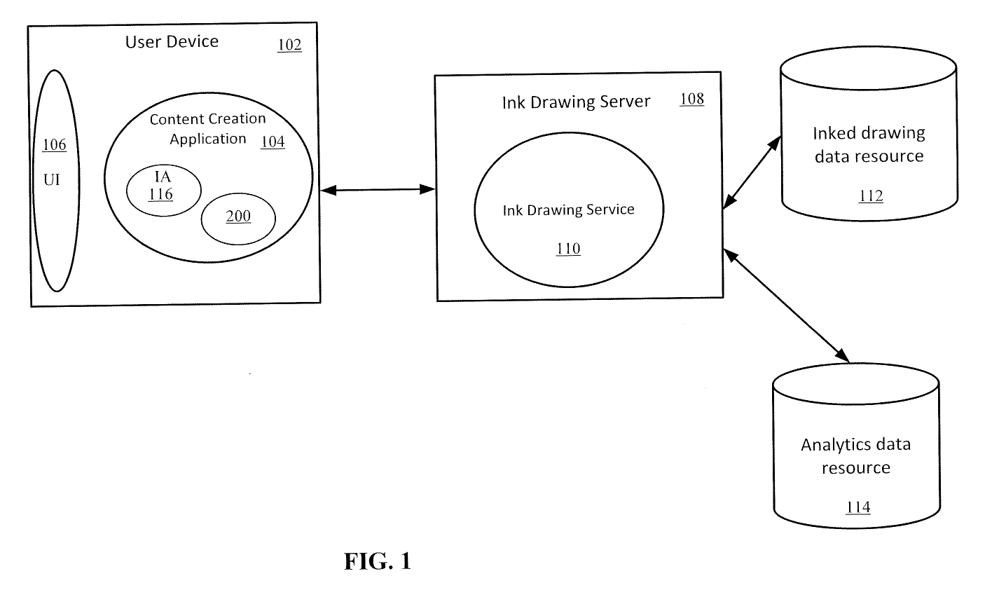

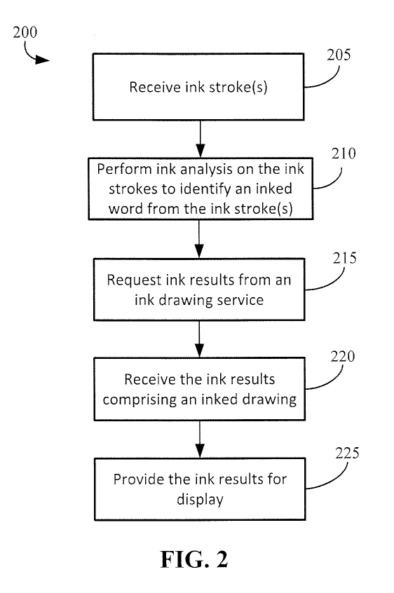

FIG. 1 illustrates an example operating environment in which various embodiments of the invention may be carried out; and FIG. 2 illustrates an example process flow diagram of a method for enhanced inking.

Referring to FIG. 1, the example operating environment may include a user device 102 running a content creation application 104 with a content creation application user interface (UI) 106 (including a canvas interface), an ink drawing server 108 implementing an ink drawing service 110, and one or more structured resources, such as inked drawing data resource 112 and analytics data resource 114, each of which may store data in structured and semi-structured formats. The content creation application 104 can include an inked drawing feature and perform process 200 as described with respect to FIG. 2. In some cases, the content creation application 104 includes an ink analyzer (IA) 116. In some cases, the content creation application 104 communicates with an external (to the application 104 or even external to the user device 102) IA.

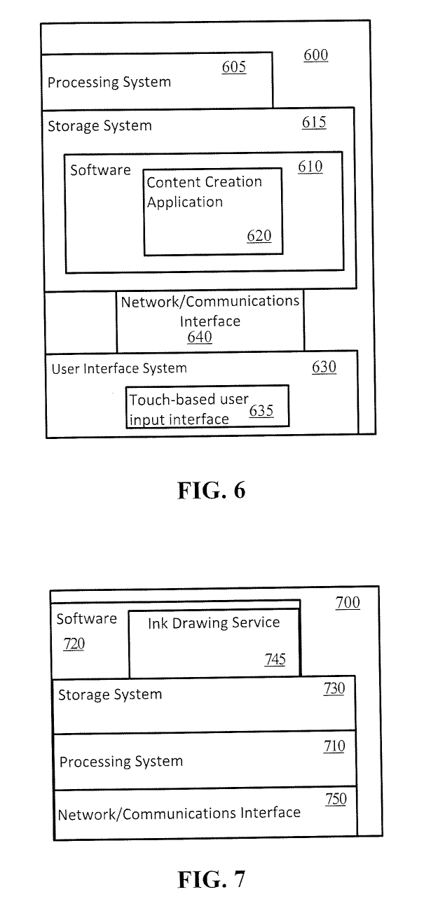

The user device 102 may be embodied as system 600 such as described with respect to FIG. 6. The ink drawing server 108 may be embodied as system 700 such as described with respect to FIG. 7.

The inked drawing data resource 112 may contain a plurality of inked drawings. Each inked drawing may be stored within an inked container and include ink strokes of the inked drawing as well as tags (and other associated metadata). Information stored in the inked container include parameters such as a start position of the ink strokes, an end position of the ink strokes, direction of the ink strokes, pressure of the ink stokes, time of the ink strokes, color of the ink strokes, thickness of the ink strokes, location of the ink strokes, and tilt. All or some of these and other parameters may be used in any suitable combination. A user identifier may also be associated with each of the inked drawings. The user identifier may be, for example, an identifier of the content creation application 104 or an identifier of the user of the content creation application 104. Further, tags that are searchable may be associated with each of the inked drawings. A user may publish an inked drawing to the inked drawing data resource 112, making the inked drawing available to the public. The metadata can include information manually annotated by a user or automatically derived by the system, or both.

In some cases, one or more of the plurality of inked drawings stored in the inked drawing data resource 112 may be user generated. For example, one or more of the inked drawings may be drawn by a user and uploaded into the inked drawing data resource 112 for sharing. In some cases, the content creation application 104 may identify that a user has drawn an inked drawing and may proactively ask the user if they would like to contribute the inked drawing to the ink drawing service 110. In some cases, one or more of the plurality of inked drawings stored in the inked drawing data resource 112 may be computationally generated. For example, a graphics card may be used to computationally generate inked drawings to store in the inked drawing data resource 112.

The user may request to upload or share inked drawings to the inked drawing data resource 112. Additionally, notifications, ratings, gamification and a reward system around drawings user's upload to service may be provided. A more detailed discussion of an inked drawing upload will be discussed later.

The analytics data resource 114 may contain search information and selection information from a plurality of users. The search information and selection information may be analyzed to form insights, including global popularities within the content creation application. The global popularities may show, for example, what the current most popular preferences are for certain inked drawings or which inked drawings have been selected the most during the last three hours. The analytics data resource 114 may also contain an attribution tree for each of the inked drawings, allowing the history of any user who edited the inked drawing to be viewed. It should be understood that these data sets may be stored on a same or different resource and even stored as part of a same data structure. Furthermore, it should be understood that any information collected regarding usage, attribution, or any other user-related data would be collected according to permissions provided by a user (as well as any privacy policies).

Components (computing systems, storage resources, and the like) in the operating environment may operate on or in communication with each other over a network (not shown). The network can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

Communication to and from the components such as between the inked drawing feature and the ink drawing service may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Referring to both FIG. 1 and FIG. 2, the content creation application 104 can receive, via the content creation application UI 106 and more specifically in some cases via a canvas interface of the content creation application 104, ink strokes from a user (205).

The content creation application 104 may run the IA 116 to perform ink analysis on the received ink strokes to identify an inked word from the ink strokes (210). The IA 116 may run as an automatic background process and/or upon command of the user. The IA 116 can recognize the inked word and determine a text-based version of the inked word. For example, a user may ink the word “truck” on the UI 106 of the content creation application 104. The content creation application 104 can then run the IA 116. The IA 116 can analyze the ink strokes and determine that a string of characters forming the word “truck” was inked. In some cases, the IA 116 may be included in a service separate from the content creation application 104. In this case, the content creation application 104 may communicate with a separate service that includes the IA 116 to perform the ink analysis to identify the inked word.

Once the content creation application 104 understands that the ink strokes identify an inked word, the content creation application 104 can, as part of the inked drawing feature, communicate to the ink drawing service 110 to request ink results (215). The request may include the text based version of the inked word. In some cases, the request may also include time and a user identifier. The ink drawing service 110 may use the time as a factor when ranking the ink results. For example, the ink drawing service may analyze the times of all the requests to determine what inked word has been requested the most.

The content creation application 104 can then receive the ink results from the ink drawing service 110 (220). The ink results include at least one inked drawing associated with the inked word. The at least one inked drawing is a digital ink drawing and therefore has an ink modifiable format. The ink results may be ranked and sorted by the ink drawing service 110 based on the insights formed by analyzing the search information and the selection information in the analytics data resource 114.

The content creation application 104 can then provide the ink results for display to the user through the content creation UI 106. The ink results may be provided to the user as a list of thumbnails of the one or more drawings. In some cases, the ink results can be received in the form of the ink container for each of the one or more inked drawing. In other cases, the ink results are initially the thumbnails or other preview format and only after selection of one of the results (for insertion into the canvas interface) by a user would the ink container be provided to the application.

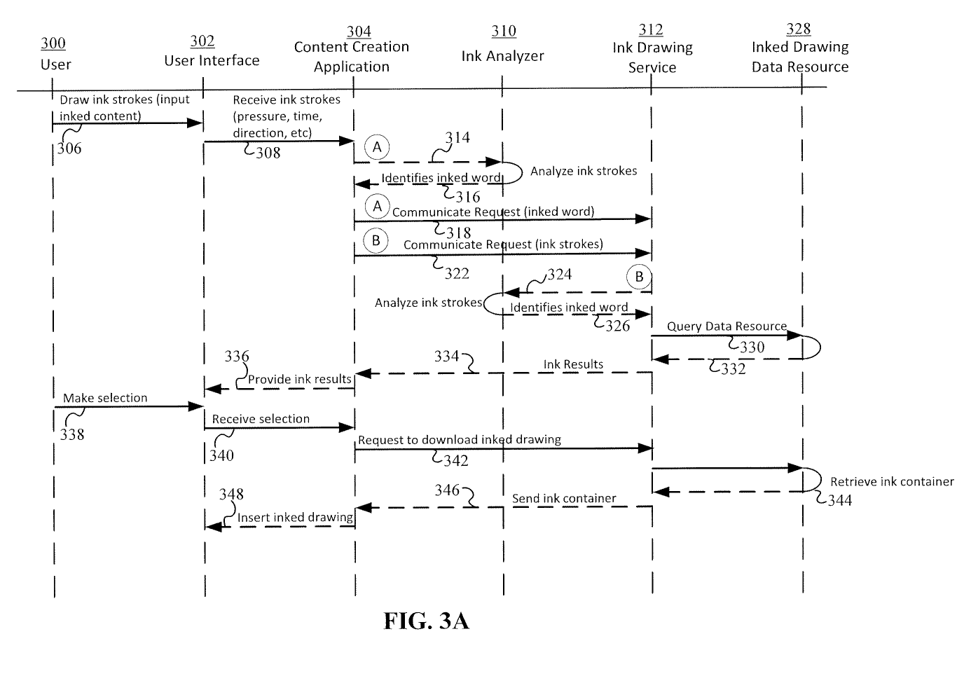

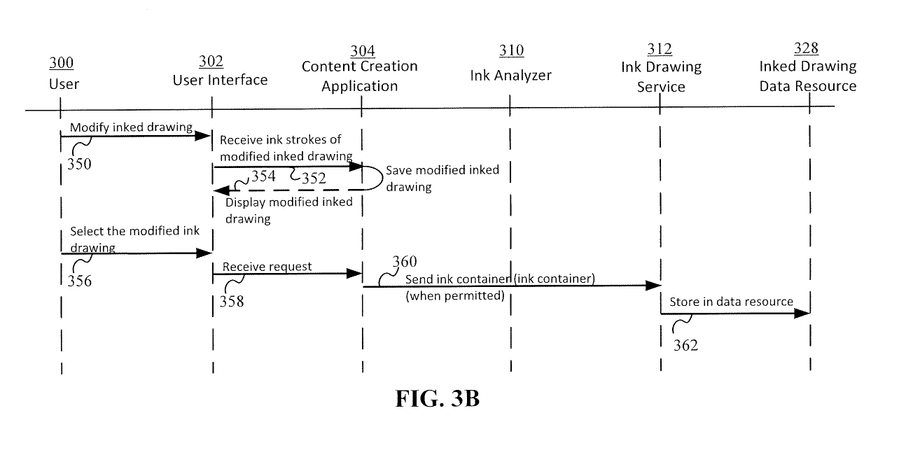

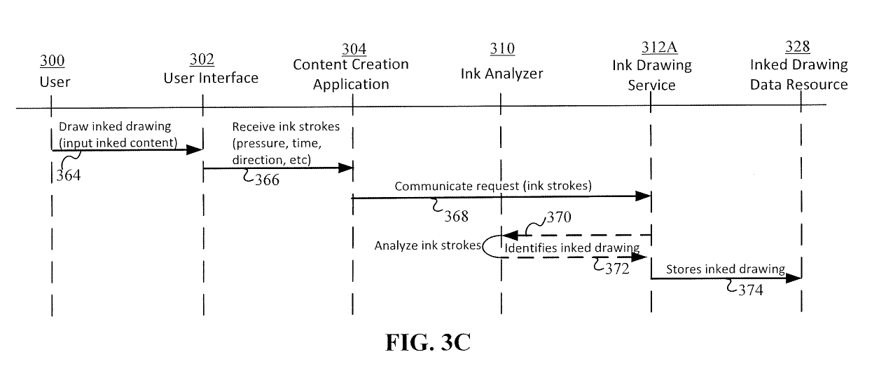

FIGS. 3A-3C illustrate a sequence diagram with example process flows. Referring to FIG. 3A, the sequence flow can begin when a user 300 interacts with a user interface 302 of a content creation application 304 to input inked content (306). To input the inked content (306), the user 300 may draw ink strokes to form an inked word or inked drawing on a canvas of the content creation application 304. The content creation application 304 can receive the ink strokes (308) along with the parameters of the ink strokes, such as pressure, color, direction, and time.

The content creation application 304 may include an ink analyzer (IA) 310 or communicate with a service that includes the IA 310. In some cases, the IA 310 may be included in an ink drawing service 312. In case A, the IA 310 is included in the content creation application 304 (or as part of an IA service that the content creation application 304 calls). In case B, the ink analyzer 310 is included in (or an IA service called by) the ink drawing service 312.

In case A, when the content creation application 304 receives the ink strokes (308), the content creation application 304 may run the IA 310 to perform ink analysis (314) on the ink strokes to identify the inked word (316) from the ink strokes. The IA 310 can recognize the inked word and return a text-based version of the inked word to the content creation application 304. The content creation application 304 can then communicate a request for ink results (318) to the ink drawing service 312. The request may include the inked word determined by the IA 310.

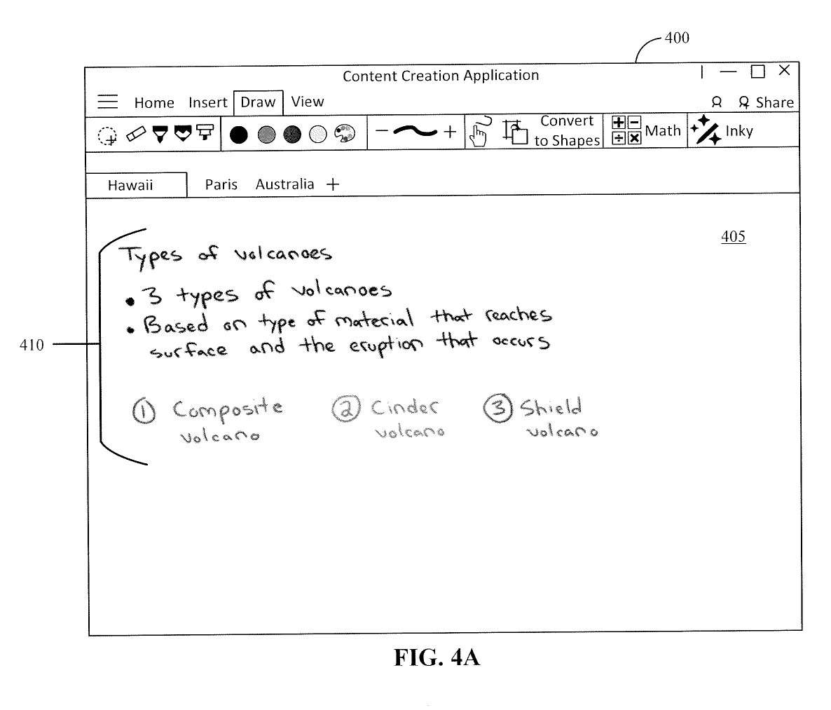

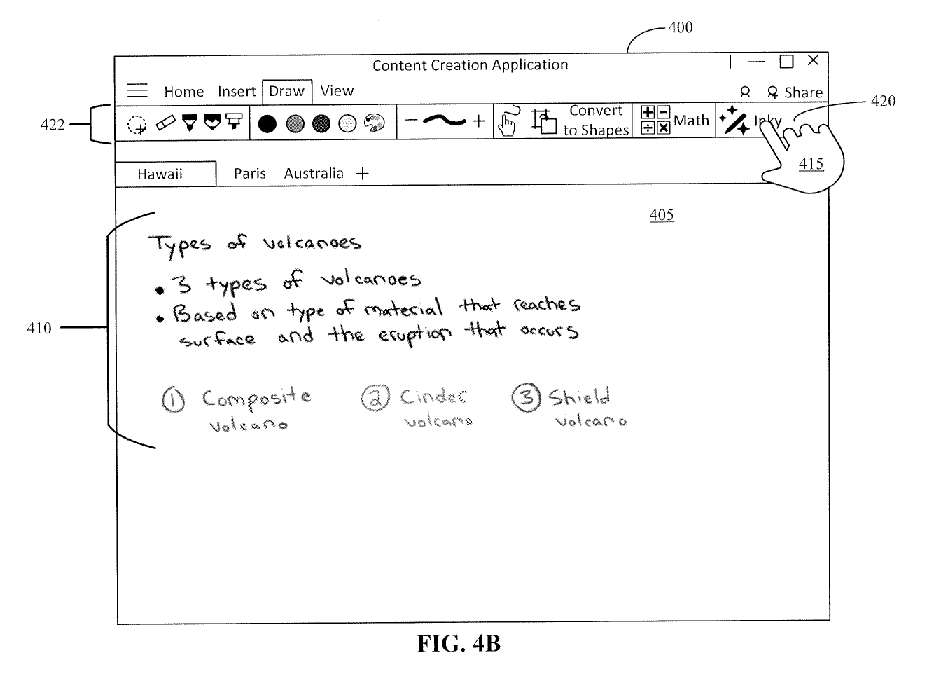

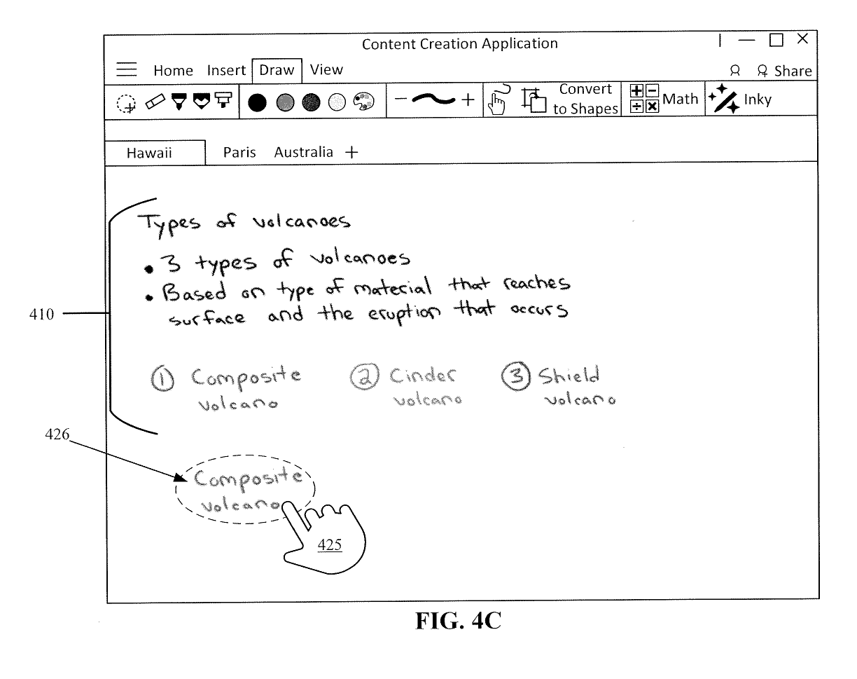

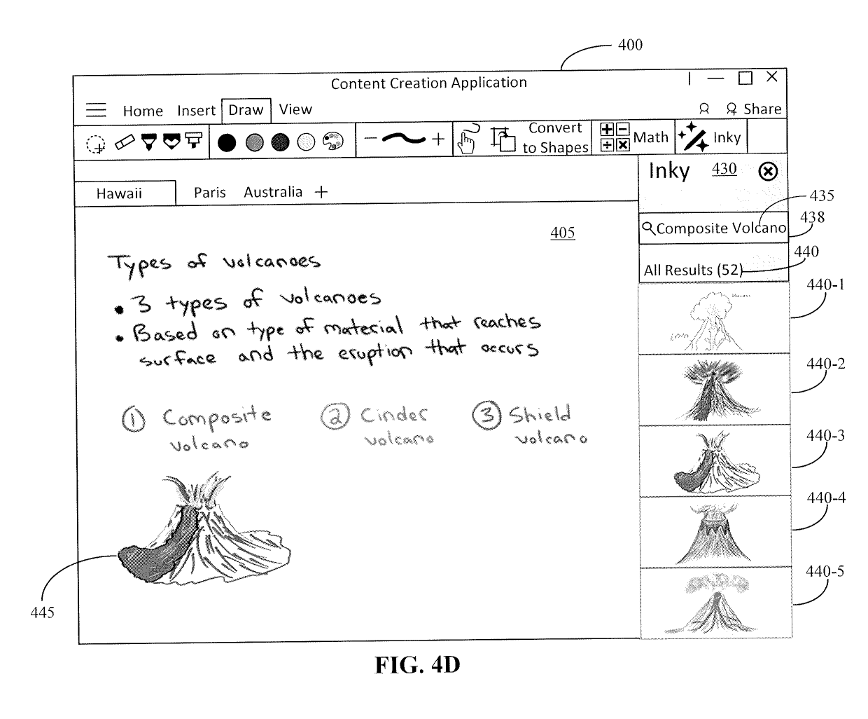

In case B, when the content creation application 304 receives the ink strokes (308), the content creation application 304 may communicate a request for ink results (320) to the ink drawing service 312, but unlike case A, the request includes the ink strokes. Then, the ink drawing service 312 can run the IA 310 to perform ink analysis (324) on the ink strokes to identify the inked word (326) from the ink strokes. Although not shown in the sequence diagram, the inked words identified by the IA can also be provided to the user. The identified inked words can be shown to the user before and/or with the ink results (e.g., after operation 316 or after operation 326). In some cases, the user can change, update, and/or correct the inked words used to obtain the ink results (see e.g., description of field 435 of FIG. 4D).

In any case, the ink drawing service 312 manages an inked drawing data resource 328. The ink drawing service 312 can query (330) the inked drawing data resource 328 for ink results using the identified inked word (332). The ink results can include at least one inked drawing associated with the identified inked word. The ink drawing service 312 can then provide the ink results (334) to the content creation application 304.

The content creation application 304 can provide the ink results (336) to the user 300 through the user interface 302. In some cases, the ink results may be presented to the user 300 as a list of thumbnails of the one or more inked drawings. In some cases, the identified inked words can be presented with the list of thumbnails. The user 300 may then make a selection (338) of one of the one or more inked drawings to insert into the canvas of the content creation application 304. The content creation application 304 can receive the selection (340) from the user 300 for an inked drawing from the ink results. The content creation application 304 can then request to download (342) the selected inked drawing from the ink drawing service 312. The ink drawing service 312 can retrieve the ink container of the selected inked drawing (344) from the inked drawing data resource 328. The ink drawing service 312 can then send the ink container (346) to the content creation application 304. The content creation application 304 can then insert the inked drawing (348) into the canvas interface of the content creation application 304.

In some cases, the content creation application 304 can insert the inked drawing in place of the inked word on the canvas interface. In some cases, the content creation application 304 can analyze the canvas to understand what the context of the canvas is. When inserting the inked drawing, the content creation application 304 can be smart about changing the visuals of the inked drawing to match the canvas of the user 300. For example, if the user 300 has started writing notes about the inked drawing, the content creation application 304 can insert the inked drawing near the notes or where the last inked spot on the canvas was. The content creation application 304 can analyze the elements of the theme of the canvas. For example, if all the ink strokes are blue, then the content creation application 304 can insert the inked drawing in blue (e.g., by changing the color parameter of ink strokes of the inked drawing to a blue).

In some cases, when the ink drawing service 312 sends the ink results (334) to the content creation application 304, the ink drawing service 312 may send the ink container. In this case, the content creation application 304 does not need to separately request to download the inked drawing from the ink drawing service 312.

Referring to FIG. 3A, since inked drawings are digital ink and in a modifiable format, the user 300 may modify the inked drawing (350) through the user interface 302. The user 300 may modify the inked drawing by adding ink strokes to the inked drawing, removing ink strokes from the inked drawing, or changing a parameter of an ink stroke of the inked drawing, such as, for example, color, thickness, direction, beginning point, or end point. The content creation application 304 may receive the modification to the ink strokes of the inked drawing (352), save the modified inked drawing and display the modified ink drawing (354) to the user 300 through the user interface 302.

The user 300 may then select the modified drawing (356), for example, by free-from selection of the drawing. In some cases, the user 300 may select the modified drawing to upload to the inked drawing data resource 328. The content creation application 304 can receive the request (358) from the user 300 and then, when permitted, send an ink container with the inked drawing (360) to the ink drawing service 312. The ink drawing service 312 can then store the ink container (362) in the inked drawing data resource 328. In some cases, the ink drawing service 312 may store the inked drawing with the already associated tags (from the original inked drawing). In other cases, the ink drawing service 312 may ask the user 300 if they would like to keep the already associated tags and/or add new tags. The inked drawing and associated metadata may then be included with the rest of the stored inked drawings when the ink drawing data resource 328 is queried in subsequent requests for inked drawings.

FIG. 3C illustrates a scenario for an enhanced ink drawing service 312A. Referring to FIG. 3C, the user 300 may draw in a canvas interface (UI 302) of a content creation application 304 to input inked content (364). The content creation application 304 can receive the ink strokes (366) of the inked content, including the ink stroke parameters and send the ink strokes (368) to the ink drawing service 312A. The ink drawing service 312A can then run the IA 310 to perform ink analysis (370) on the ink strokes similar to that described with respect to case B in FIG. 3A; however, for the enhanced ink drawing service, when the IA 310 identifies that the ink strokes are an inked drawing (372) (and not an inked word), the ink drawing service can obtain information about the inked drawing and then store the inked drawing (374) in the inked drawing data resource 328.

In some cases, the ink drawing service 312A may obtain information about the inked drawing by sending a request to the content creation application 304 to ask the user 300 to provide more information about the inked drawing, such as tags, before storing the inked drawing at the inked drawing data resource 328. In other cases, the ink drawing service 312A may obtain information about the inked drawing by performing an image analysis on the inked drawing and automatically assign tags to the inked drawing. In this case, the ink drawing service 312A can either directly store the inked drawing along with the assigned tags or get a confirmation from the user 300 before storing the inked drawing.

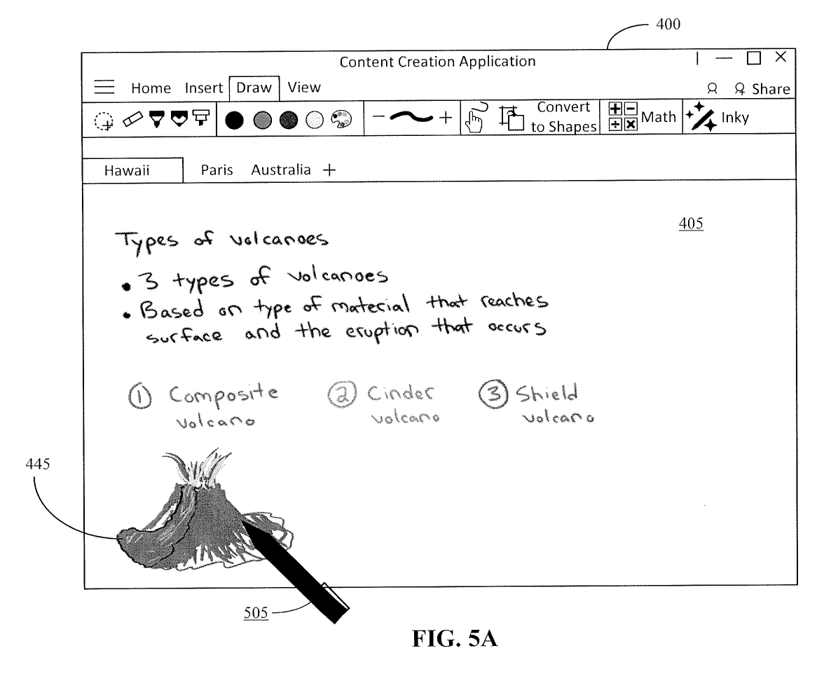

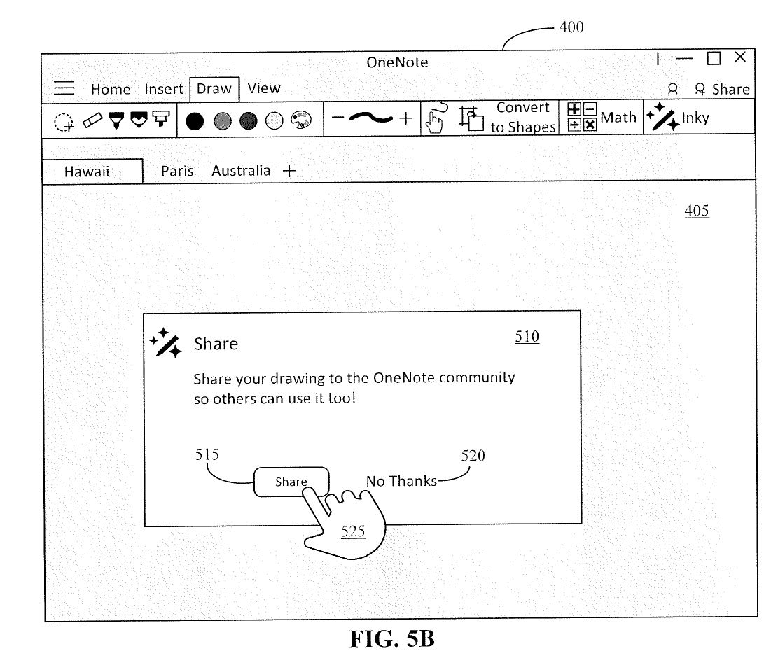

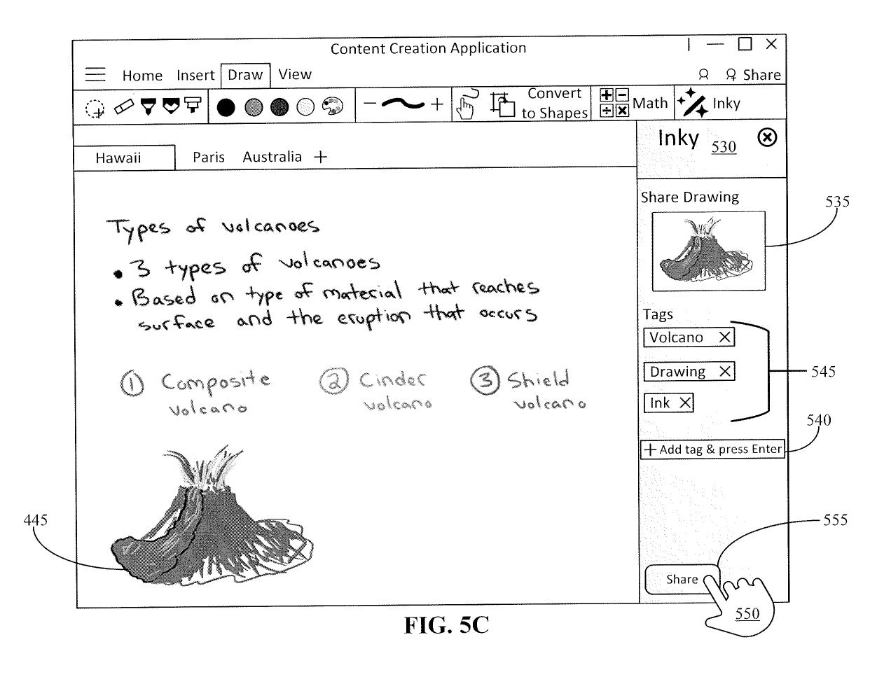

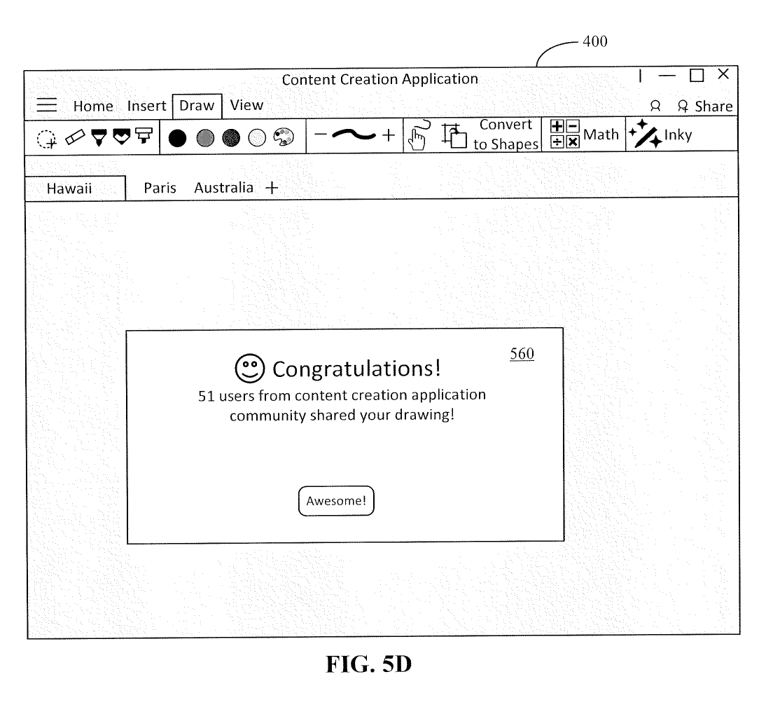

FIGS. 4A-4D and 5A-5D illustrate example scenarios of enhanced inking carried out at a content creation application. A user may open a canvas interface 405 of a content creation application 400 on their computing device (embodied, for example, as system 600 described with respect to FIG. 6). The computing device can be any computing device such as, but not limited to, a laptop computer, a desktop computer, a tablet, a personal digital assistant, a smart phone, a smart television, a gaming console, wearable device, and the like.

Referring to FIG. 4A, the user may input inked content 410 onto the canvas interface 405 of the content creation application 400 without the need for a keyboard. The inked content 410 may include inked words or inked drawings. For example, a user may be writing a report on volcanoes. In this case, the inked content 410 may include handwritten words associated with volcanoes, such as the “Types of volcanoes”, “composite volcano”, “cinder volcano”, and “shield volcano”.

Referring to FIG. 4B, while the inked content 410 is still shown on the canvas interface 405 of the content creation application 400, the user may decide they would like help drawing a picture of one of the inked words in the inked content 410. In this case, the user may select a command for an inked drawing functionality (415), such as inky command 420, located in a toolbar 422 of the content creation application 400. In some cases, the content creation application 400 may display an information box that allows the user to receive information about how to use the inked drawing functionality.

Referring to FIG. 4C, the user can select one or more of the inked words from the inked content 410 to be used in a query for an associated inked drawing and/or write the words of the topic for the inked drawing. In the example of FIG. 4C, the user may have written and selected (425) the inked words “composite volcano” 426. The selection 425 action may be any suitable input such as touch, encircle, and the like. Although a finger is illustrated as the inking input tool, a pen or stylus or other object may be used. Other mechanisms for initiating the command to transform inked words to an inked drawing may be used as well. For example, in some cases, selecting the command for the inked drawing functionality may cause any subsequently written word to be automatically used in a query for an associated inked drawing without a separate step of selecting.

Referring to FIG. 4D, when the user selects one or more of the inked words (as shown in FIG. 4C), a pop-out window 430 may be displayed that shows inked drawing results 440 of a search of the inked drawing data resource using the selected inked words 435. In the example of FIG. 4D, an input field 438 displays the text 435 corresponding to the selected inked words “composite volcano”. The inked drawing results 440 may be presented as thumbnails, such as inked drawing 440-1, inked drawing 440-2, inked drawing 440-3, inked drawing 440-4, and inked drawing 440-5. The user can select one of the inked drawing results 440 to insert into the canvas interface 405 of the content creation application 400. The inked drawing 445 that was selected can then be inserted into the canvas interface 405. The inked drawing 445 inserted into the canvas interface 405 is a digital inked drawing and therefore is of an ink modifiable format (as opposed to a static drawing).

According to the illustrated implementation, the inked drawing 445 is inserted in place of the inked word 426, providing an effect where an inked word is transformed to an inked drawing. In some implementations, the inked drawing may be inserted into the canvas interface 405 at a location that the user actively (by dragging into place) or passively (by the user's last ink stroke or other status used by the system) identifies for insertion. In some of such cases, the written word(s) remain(s) in addition to the inserted inked drawing. For example, the user could have selected the “composite volcano” already written in the content 410 instead of writing the term specifically to be transformed as reflected in FIGS. 4C and 4D.

In some cases, the field 435 displaying the inked words used to obtain the ink results may be modified by the user. Further, the pop-out window 430 may display an alternative word list to the user. For example, if an ink analysis of the word “volcano” surfaced “volume”, the content creation application 400 can surface a list of three to five alternative words of lower confidence. Therefore, if a list of “volume bar” inked drawings is displayed, the user can instead select the word “volcano” from the alternative word list.

Referring to FIG. 5A, advantageously, because the inked drawing 445 is a digital inked drawing, once the inked drawing 445 is inserted into the canvas interface 405 of the content creation application 400, the user can interact with the inked drawing 445 as if the user had drawn the inked drawing themselves. The user may modify the inked drawing 445 by, for example, annotating the inked drawing 445, adding ink strokes, removing ink strokes, or changing parameters of the ink strokes, such as color or thickness.

In the example of FIG. 5A, the user can add or modify ink strokes (505) to the inked drawing 445 of a composite volcano. The modifications to the inked drawing 445 can be saved by the content creation application 400.

Referring to FIG. 5B, the user may decide to share the modified inked drawing so others can use the inked drawing. In some cases, the user may select the modified inked drawing to be shared. In other cases, the content creation application 400 may automatically ask the user if they would like to share the modified inked drawing.

In the example of FIG. 5B, a sharing window 510 can be displayed over the canvas (e.g., canvas interface 405) of the content creation application 400 asking the user if they would like to share their drawing. If the user would like to share their inked drawing, the user can select a command to share, such as share command 515. If the user would not like to share their inked drawing, the user can select a command to not share, such as no thank you command 520.

Referring to FIG. 5C, a share drawing window 530 may be displayed to the user. The share drawing window 530 may include a thumbnail of the inked drawing to be shared. The share drawing window 530 may also include a tag input field 540 to allow the user to enter a tag for the inked drawing.

In the example of FIG. 5C, a thumbnail 535 of inked drawing 445 may be displayed in the share drawing window 530. Further, tags 545 associated with the inked drawing 445 are displayed. The tags 545 include a volcano tag, a drawing tag, and an ink tag.

When the user is ready to upload the ink drawing 445, the user can select a command to share (550), such as share command 555.

In some embodiments, the share drawing window 530 may include a section for other preferences, such as for preferences for digital rights management. For example, the user may decide to share their inked drawings, but may not want to allow other users to modify their inked drawing.

Referring to FIG. 5D, if a user has uploaded a new inked drawing or uploaded a modified ink drawing, then when the user opens the content creation application 400, the user may receive a notification stating how many times the uploaded inked drawing has been shared.

In the example of FIG. 5D, a notification window 560 can be displayed to the user. The notification window 560 can inform the user, for example, that, “51 users from the content creation application community has shared their inked drawing”.

FIG. 6 illustrates components of a computing device that may be used in certain embodiments described herein; and FIG. 7 illustrates components of a computing system that may be used to implement certain methods and services described herein.

Referring to FIG. 6, system 600 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen. Accordingly, more or fewer elements described with respect to system 600 may be incorporated to implement a particular computing device.

System 600 includes a processing system 605 of one or more processors to transform or manipulate data according to the instructions of software 610 stored on a storage system 615. Examples of processors of the processing system 605 include general purpose central processing units, application specific processors, and logic devices, as well as any other type of processing device, combinations, or variations thereof. The processing system 605 may be, or is included in, a system-on-chip (SoC) along with one or more other components such as network connectivity components, sensors, video display components.

Software 610 may be implemented in program instructions and among other functions may, when executed by system 600 in general or processing system 605 in particular, direct system 600 or the one or more processors of processing system 605 to operate as described herein.

The software 610 can include an operating system and application programs such as a content creation application 620 that calls the ink drawing service as described herein. Device operating systems generally control and coordinate the functions of the various components in the computing device, providing an easier way for applications to connect with lower level interfaces like the networking interface. Non-limiting examples of operating systems include WINDOWS from Microsoft Corp., APPLE iOS from Apple, Inc., ANDROID OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 6, can be thought of as additional, nested groupings within the operating system space, each containing an OS, application programs, and APIs.

Storage system 615 may comprise any computer readable storage media readable by the processing system 605 and capable of storing software 610 including the content creation application 620.

Storage system 615 may include volatile and nonvolatile memories, removable and non-removable media implemented in any method or technology for storage of information, such as computer readable instructions, data structures, program modules, or other data. Examples of storage media of storage system 615 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 615 may be implemented as a single storage device but may also be implemented across multiple storage devices or sub-systems co-located or distributed relative to each other. Storage system 615 may include additional elements, such as a controller, capable of communicating with processing system 605.

The system can further include user interface system 630, which may include input/output (I/O) devices and components that enable communication between a user and the system 600. User interface system 630 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input. In some implementations, for inclusion of the described inking feature, the user interface system 630 at least includes a digitizer. The touch-based user input interface 635 can include a touchscreen and/or surface with sensing components for a digitizer. In some cases, a digitizing pen may be used in place of or as part of the touch-based user input interface 635.

The user interface system 630 may also include output devices such as display screen(s), speakers, haptic devices for tactile feedback, and other types of output devices. In certain cases, the input and output devices may be combined in a single device, such as a touchscreen display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display (not shown) in myriad ways, presenting graphical user interface elements, text, images, video, notifications, virtual buttons, virtual keyboards, or any other type of information capable of being depicted in visual form.

The user interface system 630 may also include user interface software and associated software (e.g., for graphics chips and input devices) executed by the OS in support of the various user input and output devices. The associated software assists the OS in communicating user interface hardware events to application programs using defined mechanisms. The user interface system 630 including user interface software may support a graphical user interface, a natural user interface, or any other type of user interface. For example, the canvas interfaces for the content creation application 620 described herein may be presented through user interface system 630.

Network interface 640 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Certain aspects described herein, such as those carried out by the ink drawing service described herein may be performed on a system such as shown in FIG. 7. Referring to FIG. 7, system 700 may be implemented within a single computing device or distributed across multiple computing devices or sub-systems that cooperate in executing program instructions. The system 700 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 700 can include a processing system 710, which may include one or more processors and/or other circuitry that retrieves and executes software 720 from storage system 730. Processing system 710 may be implemented within a single processing device but may also be distributed across multiple processing devices or sub-systems that cooperate in executing program instructions.

Storage system(s) 730 can include any computer readable storage media readable by processing system 710 and capable of storing software 720. Storage system 730 may be implemented as a single storage device but may also be implemented across multiple storage devices or sub-systems co-located or distributed relative to each other. Storage system 730 may include additional elements, such as a controller, capable of communicating with processing system 710. Storage system 730 may also include storage devices and/or sub-systems on which data such as inked drawing information is stored.

Software 720, including ink drawing service 745, may be implemented in program instructions and among other functions may, when executed by system 700 in general or processing system 710 in particular, direct the system 700 or processing system 710 to operate as described herein for the ink drawing service (and its various components and functionality).

System 700 may represent any computing system on which software 720 may be staged and from where software 720 may be distributed, transported, downloaded, or otherwise provided to yet another computing system for deployment and execution, or yet additional distribution.

In embodiments where the system 700 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A network/communication interface 750 may be included, providing communication connections and devices that allow for communication between system 700 and other computing systems (not shown) over a communication network or collection of networks (not shown) or the air.

Certain techniques set forth herein with respect to the content creation application and/or ink service may be described in the general context of computer-executable instructions, such as program modules, executed by one or more computing devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method for enhanced inking comprising:
receiving ink strokes through a canvas interface of a content creation application;
displaying the ink strokes on the canvas interface;
performing ink analysis on the ink strokes to identify an inked word drawn by the ink strokes;
communicating to an ink drawing service a request for ink results corresponding to the inked word, the request comprising a text-based version of the inked word;
receiving the ink results from the ink drawing service, the ink results comprising an inked drawing related to the inked word, the inked drawing comprising ink strokes and having an ink modifiable format; and
providing the ink results for display concurrently with the inked word.

2. The method of claim 1, further comprising:
receiving a selection to insert the inked drawing into the canvas interface; and
inserting the inked drawing in place of the inked word on the canvas interface.

3. The method of claim 1, further comprising:
receiving a modification to the inked drawing;
saving the modified inked drawing.

4. The method of claim 3, wherein the modification comprises adding one or more ink strokes to the inked drawing.

5. The method of claim 3, wherein the modification comprises removing one or more of the ink strokes of the inked drawing.

6. The method of claim 3, wherein the modification comprises changing a parameter of at least one ink stroke of the inked drawing.

7. The method of claim 6, wherein the parameter comprises a color, a thickness, a direction, a beginning point, or an end point.

8. A system for content creation, comprising:
a touch-based user input interface;
a processing system;
a network interface;
one or more storage media;
a content creation application with an inked drawing feature stored on at least one of the one or more storage media that, when executed by the processing system, direct the processing system to:
receive ink strokes, via the touch-based user input interface, through a canvas interface of the content creation application;
display the ink strokes on the canvas interface;
perform ink analysis on the ink strokes to identify an inked word drawn by the ink strokes;
communicate to an ink drawing service, via the network interface, a request for ink results corresponding to the inked word, the request comprising a text-based version of the inked word;
receive the ink results from the ink drawing service, the ink results comprising an inked drawing related to the inked word, the inked drawing comprising ink strokes and having an ink modifiable format; and
provide the ink results for display concurrently with the inked word.

9. The system of claim 8, wherein the content creation application with the inked drawing feature further direct the processing system to:
receive a selection to insert the inked drawing into the canvas interface; and
insert the inked drawing in place of the inked word on the canvas interface.

10. The system of claim 8, wherein the content creation application with the inked drawing feature further direct the processing system to:
receive a modification to the inked drawing;
save the modified inked drawing.

11. The system of claim 10, wherein the modification comprises adding one or more ink strokes to the inked drawing.

12. The system of claim 10, wherein the modification comprises removing one or more of the ink strokes of the inked drawing.

13. The system of claim 10, wherein the modification comprises changing a parameter of at least one ink stroke of the inked drawing.

14. The system of claim 13, wherein the parameter comprises a color, a thickness, a direction, a beginning point, or an end point.

15. One or more computer readable storage media having instructions for a content creation application with inked drawing feature stored thereon what when executed by a processing system direct the processing system to at least:
receive ink strokes through a canvas interface of the content creation application;
display the ink strokes on the canvas interface;
perform ink analysis on the ink strokes to identify an inked word drawn by the ink strokes;
communicate to an ink drawing service a request for ink results corresponding to the inked word, the request comprising a text-based version of the inked word;
receive the ink results from the ink drawing service, the ink results comprising an inked drawing related to the inked word, the inked drawing comprising ink strokes and having an ink modifiable format; and
provide the ink results for display concurrently with the inked word.

16. The media of claim 15, further comprising instructions that direct the processing system to:
receive a selection to insert the inked drawing into the canvas interface; and
insert the inked drawing in place of the inked word on the canvas interface.

17. The media of claim 15, wherein the instructions further direct the processing system to:
receive a modification to the inked drawing;
save the modified inked drawing.

18. The media of claim 17, wherein the modification comprises adding one or more ink strokes to the inked drawing or removing one or more of the ink strokes of the inked drawing

19. The media of claim 17, wherein the modification comprises changing a parameter of at least one ink stroke of the inked drawing.

20. The media of claim 19, wherein the parameter comprises a color, a thickness, a direction, a beginning point, or an end point.
